(19) United States
(12) Patent Application Publication
(10) Pub. No.: US 2009/0115240 A1
(43) Pub. Date: May 7, 2009

(54) BICYCLE WHEEL RIM

(76) Inventors: Mark Slate, San Rafael, CA (US); Josh Deetz, Taiping City (TW); Patrick Seidler, San Rafael, CA (US)

Correspondence Address: STAINBROOK & STAINBROOK, LLP, 412 AVIATION BOULEVARD, SUITE H, SANTA ROSA, CA, 95403, US

(21) Appl. No.: 12/065,492

(22) PCT Filed: Aug. 30, 2006
(86) PCT No.: PCT/US06/34082

§ 371 Date: Jul. 29, 2008

Related U.S. Application Data
(60) Provisional application No. 60/712,714, filed on Aug. 30, 2005.

(51) Int. Cl. B60B 21/02

(52) U.S. Cl. 301/95.104

(57) ABSTRACT

A bicycle wheel rim having rim walls joined at their proximal ends by an inner annular bridge, an annular outer bridge disposed at the approximate midpoint of the rim walls, and a vertical beam disposed between the outer and inner bridges.

### BACKGROUND OF THE INVENTION

1. Technical Field

The present invention relates generally to bicycle wheel rims, more particularly to a bicycle wheel rim having an improved tire bead retention system, and further having a novel vertical beam disposed between inner and outer bridge structures which strengthens the rim.

2. Background Art

Bicycle wheels are well known in the art, generally having two spaced-apart annular tire retaining walls connected by an annular spoke mounting wall disposed between the radial inner walls of the two annular tire retaining walls. As materials technology has matured, several improvements have been introduced into wheel rim designs. In particular, metal alloys and composition materials, such as carbon fiber, have been increasingly employed to reduce weight and to add strength and stability.

Different tire systems demand different shapes for the retention of such tires. High speeds, rough terrain, and heavier riders have further increased the need for more robust wheel rims and better tire retention systems. A few noteworthy developments merit brief consideration.

Pat. App. Pub. No. US 2003/0025383 A1 and US 2002/0079035 A2, for instance, each to LaCombe, disclose rim structures for a bicycle wheel that includes at its periphery, an annular channel designed to receive a bicycle tire being demarcated by an upper bridge devoid of any opening, with the exception of the valve opening, and two lateral flanges having end butts for gripping the tire.

U.S. Pat. No. 6,428,115, to Chao-Ying Chen, describes a wheel rim body with annular left and right tire retaining walls, an annular spoke mounting wall and a tire retaining cavity. Each of the tire retaining walls has a radial inner edge proximal to a central axis of the rim body and a radial out edge distal to the central axis.

U.S. Pat. No. 6,474,746, to Campagnolo, discloses a rim for a spoked bicycle wheel having a tubeless tire comprising a continuous circumferential wall without any holes or openings, and a plurality of support for nipples for tightening spokes, the said supports supporting the nipples outside the section making up the rim.

U.S. Pat. No. 6,237,662, to Thomasberg, describes a tubeless tire rim formed with openings having opposing recesses configured to engage corresponding tire beads. With the beads engaged in the recesses, the tire and rim seal to form an airtight, sealed chamber, such that no inner tube is necessary.

The foregoing patents and prior art devices reflect the current state of the art of which the present inventor is aware. Reference to, and discussion of, these patents is intended to aid in discharging Applicant's acknowledged duty of candor in disclosing information that may be relevant to the examination of prospective claims to the present invention. However, it is respectfully submitted that none of the above-indicated patents disclose, teach, suggest, show, or otherwise render obvious, either singly or when considered in combination, the invention described herein. Specifically, none of the known prior art shows a tire bead retention system spanning several tire configurations, nor a strait beam incorporated between the inner and outer bridge structures to strengthen the rim.

### DISCLOSURE OF INVENTION

The present invention is a bicycle wheel rim with an improved tire bead retention system. The inventive rim also includes a novel vertical beam disposed between inner bridge and outer bridge structures to strengthen the rim.

The bicycle wheel rim of the present invention includes a left annular ring forming the second rim wall and a right annular ring forming the first rim wall, joined to one another at their respective distal inner edges by an annular inner bridge. The inner bridge has openings to accommodate the insertion of spokes to support the rim on a hub.

An annular outer bridge is disposed approximately at the midpoint of the second rim wall and the first rim wall and parallel to the inner bridge. The outer bridge has a central well defined by a first lateral wall and a second lateral wall, which are joined to the second rim wall and the first rim wall, respectively, by a first bead seat and a second bead seat. The joining of the bead seats may be accomplished by a welded joint or a pinned joint. The central well is of sufficient depth to accommodate access apertures for wheel spokes and to accommodate rim tape to cover the spoke ends.

The first bead seat and the second bead seat are essentially parallel to the inner bridge. The proximal portion of the first bead seat and the second bead seat each exhibit a stasis bump projecting outwardly near the lateral wall and descending to the radial plane of the bead seat. The stasis bumps serve to prevent tire bead slippage inwardly on the rim.

The second rim wall and the first rim wall extend above the outer bridge and each terminate in an inwardly projecting tire bead retention hook. The tire bead retention hook can be made in variable widths to accommodate different tire and tire bead dimensions for different applications of bicycle riding. As rim width increases, the cavity created between the stasis bump and the tire bead hook is increased to fit the larger bead dimensions of the wider tires.

The outer wall of each of the second rim wall and the first rim wall has a rim hook bulge located at approximately opposite the junction of the bead seat and the rim wall. The rim hook bulge adds significant strength to the tire bead hook.

Disposed between and in communication with the outer bridge and the inner bridge, and perpendicular to the radial planes of the inner and outer bridges, is a vertical beam which extends the entire circumference of the rim. The vertical beam is a ring which, when viewed in cross section, is substantially straight, with a thickness at its base (where it connects to the inner bridge) being slightly greater than its thickness where it intersects the outer bridge. The vertical beam lends increased strength and rigidity to the bicycle wheel rim.

It is thus an object of the present invention to create a stronger and more rigid bicycle wheel rim through the use of a vertical beam disposed between outer and inner bridges of the rim.

It is a further object of the present invention to provide an improved tire bead retention system utilizing a stasis bump and a bead hook to seat tire beads.

It is an even further object of the present invention to provide a bead well cavity that becomes larger as the rim becomes wider to accommodate larger tires and bead systems.

It is yet a further object of the present invention to allow the use of either tubeless or tube tires with the bicycle wheel rim.

Still other objects and advantages of the present invention will become readily apparent to those skilled in this art from the following detailed description, which shows and describes only the preferred embodiments of the invention, simply by way of illustration of the best mode now contemplated of carrying out the invention. As will be realized, the invention is capable of modification in various obvious respects without departing from the invention. Accordingly, the drawings and description of the preferred embodiment are to be regarded as illustrative in nature, and not as restrictive.

### BRIEF DESCRIPTION OF THE DRAWINGS

The invention will be better understood and objects other than those set forth above will become apparent when consideration is given to the following detailed description thereof. Such description makes reference to the annexed drawing wherein:

FIG. 1 is a cross section of the improved bicycle wheel rim;

FIG. 2 is a cross section of second embodiment of the improved bicycle wheel rim; and

FIG. 3 is a cross section of the improved bicycle wheel rim illustrating the relative dimensional changes that accompany a rim width increase, particularly the increase of the cavity volume formed by the tire bead hook and the stasis bump.

### REFERENCE NUMERAL LEGEND

100 first preferred embodiment of improved bicycle wheel rim
105 first rim wall
107 distal portion of first rim wall
109 proximal portion of first rim wall
110 second rim wall
112 distal portion of second rim wall
114 proximal portion of second rim wall
120 inner bridge
130 outer bridge
140 central well
150 first lateral wall
160 second lateral wall
170 first bead seat
180 second bead seat
182 weld
185 stasis bumps
190 tire bead hook
193 outer end of vertical beam
195 cavity
197 inner end (base) of vertical rim
198 rim hook bulge
199 vertical beam
200 second preferred embodiment
203 shoulder joint
205 hollow of shoulder joint

### BEST MODE FOR CARRYING OUT THE INVENTION

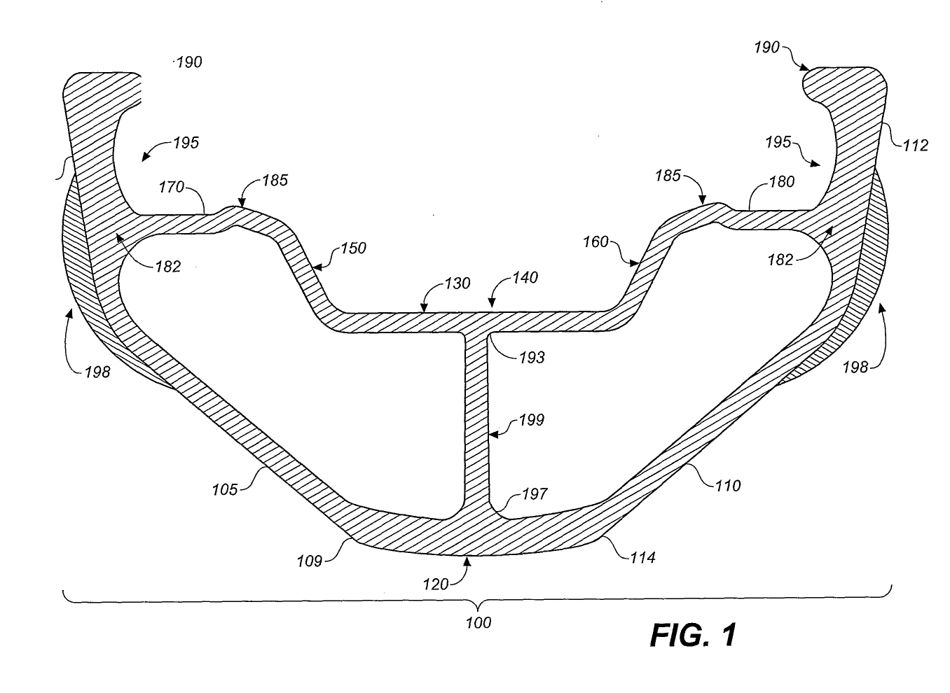

Referring to FIGS. 1 through 3, wherein like reference numerals refer to like components in the various views, there is illustrated therein a new and improved hollow bicycle wheel rim, generally denominated 100 herein.

FIG. 1 illustrates a first preferred embodiment of the improved bicycle wheel rim 100, comprising an angled annular ring forming a first rim wall 105, and an angled annular ring forming a second rim wall 110. The first rim wall includes a distal portion 107 and a proximal portion 109. The second rim wall also includes a distal portion 112 and a proximal portion 114. The first and second rim walls are joined at their respective proximal inner edges by an annular inner bridge 120.

An annular outer bridge 130 is disposed at approximately the midpoint of the second rim wall and the first rim wall and is generally parallel to the inner bridge 120. The outer bridge 130 has a central well 140 defined by a first lateral wall 150 and a second lateral wall 160, which are joined to the second rim wall 105 and the first rim wall 110, respectively, by a first bead seat 170 and a second bead seat 180. The connection of the bead seats 170 and 180 to the respective rim walls 110 and 105, may be accomplished using a weld 182 or it may comprise an integral transition from one structural element to the other. The central well 140 is of sufficient depth as to accommodate access apertures for wheel spokes and to accommodate rim tape to cover the spoke ends.

The first bead seat 170 and the second bead seat 180 are essentially parallel to the inner bridge. The proximal portion of the first bead seat 170 and the second bead seat 180 each exhibit a stasis bump 185 projecting outwardly from the plane of the bead seat proximate the top of the lateral wall, at the point the bump is higher on it proximal edge, and it decreases in prominence and descends until it merges with the radial plane of the bead seats 170 and 180. The stasis bumps 185 serve to prevent tire bead slippage inwardly on the rim.

The distal portions of the second rim wall 110 and the first rim wall 105 extend above the outer bridge 130 and each terminate in an inwardly projecting tire bead retention hook 190. The tire bead retention hook 190 can be made in variable widths so as to accommodate different tire and tire bead dimensions for different applications of bicycle riding. As rim width increases, the cavity 195 created between the stasis bump 185 and the tire bead hook 190 increases proportionately to fit the larger dimensions of the bead of wider tires.

The outer wall of the second rim wall 110 and the first rim wall 105 have a rim hook bulge 198 located at approximately opposite the junction of the bead seat 170 and 180 and the rim walls 110 and 105. The rim hook bulge 198 adds significant strength to the tire bead hook over previously described designs.

Disposed between and in communication with the inner bridge 120 and the inner bridge 130, and also perpendicular to the radial plane of the inner bridge 120, is an annular vertical beam 199. The vertical beam 199 is an essentially straight column when viewed in cross section having a thickness at its base, or inner end, 197 (where it connects, preferably integrally, with the inner bridge 120) which is slightly greater than its thickness at its outer end 193 (where it connects, preferably integrally, with the outer bridge 130). The vertical beam 199 provides increased strength and rigidity to the bicycle wheel rim and prevents catastrophic collapse under high loads at high speeds.

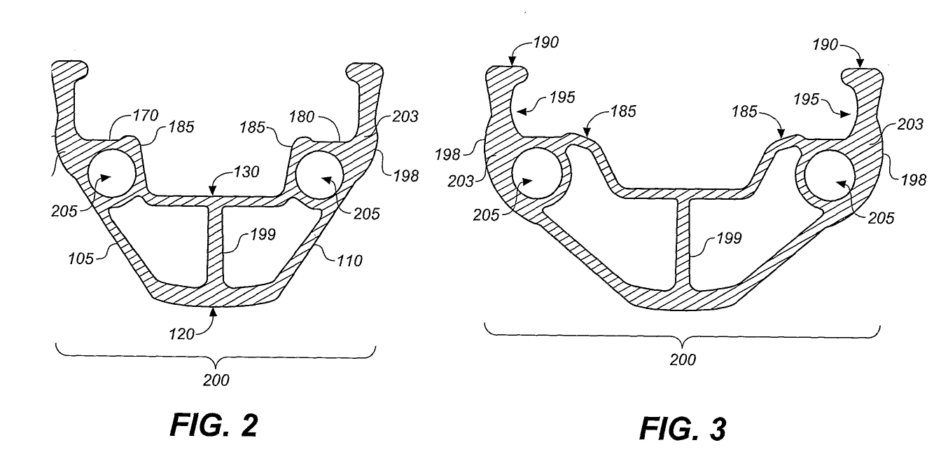

FIG. 2 is a cross section of a second preferred embodiment 200 of the improved bicycle tire rim 100 of the present invention. In this embodiment, the connection of the first bead seat 170 and the second bead seat 180 to the first and second rim walls 105, 110, is achieved by using a shoulder joint 203 defining an annular hollow 205. Once again, the vertical beam 199 is disposed between the outer bridge 130 and the inner bridge 120.

FIG. 3 is a cross section of the improved bicycle wheel rim 100 illustrating the relative dimensional changes of the second preferred embodiment necessitated by an increase in the rim width to accommodate a wider tire and larger tire bead. This is particular evident with respect to changes in the volume of cavity 195 formed by the tire bead hook 190 and the stasis bump 185.

The invention having been described in detail in accordance with requirements of the Patent Statutes, various other changes and modifications will suggest themselves to those skilled in this art. For example, as noted above, the invention may be fabricated from metal alloys or from composite materials. Additionally, the invention is not limited to any particular application or use. It is easily conceivable that the inventive rim could be used for motorcycle wheel rims; indeed, it could be adapted for use as a wheel rim for virtually any kind of inflatable tire. It is intended that these uses and other changes and modifications readily learned, appreciated, or obvious to those skilled in the relevant art shall fall within the spirit and scope of the invention defined in the appended claims.

What is claimed as invention is:

1. A bicycle wheel rim, comprising:
an annular first rim wall having a proximal portion and a distal portion;
an annular second rim wall having a proximal portion and a distal portion;
an annular inner bridge connecting said first rim wall with said second rim wall at their respective proximal portions;
an annular outer bridge disposed at the approximate midpoint of said second rim wall and said first rim wall, said outer bridge being generally parallel to said inner bridge; and
a vertical beam disposed between said outer bridge and said inner bridge.

2. The bicycle wheel rim of claim 1, wherein said outer bridge includes:
a first bead set joined to said first rim wall;
a second bead set joined to said second rim wall; and
spaced-apart first and second lateral walls defining a central well therebetween, said first lateral wall joined to said first bead seat and said second lateral wall joined to said second bead set.

3. The bicycle wheel rim of claim 2, wherein the connection between said first and second bead seats and said first and second rim wall, respectively, is a weld.

4. The bicycle wheel rim of claim 2 wherein the well is sufficiently deep to accommodate access apertures for wheel spokes.

5. The bicycle wheel rim of claim 2, wherein said first and second bead seats are essentially parallel to said inner bridge.

6. The bicycle wheel rim of claim 2, wherein said first and second bead sets each include a stasis bump projecting outwardly proximate said respective lateral walls.

7. The bicycle wheel rim of claim 7, wherein each of said stasis bump projections decreases in prominence until it merges with the plane of a bead seat.

8. The bicycle wheel rim of claim 1, wherein said first and second rim walls extend above said outer bridge and terminate in an inwardly projecting tire bead retention hook.

9. The bicycle wheel rim of claim 1, wherein said vertical beam includes a base connected to said inner bridge and an outer end connected to said outer bridge, and wherein said base is thicker than said outer end.

10. The bicycle wheel rim of claim 1, wherein said first and second bead seats are connected to their respective rim walls with a shoulder joint defining an annular hollow.
